(19) United States
(12) Patent Application Publication
(10) Pub. No.: US 2025/0314323 A1
(43) Pub. Date: Oct. 9, 2025

(54) FLOW CONTROL DEVICE, METHOD, AND SYSTEM

(71) Applicant: Baker Hughes Oilfield Operations LLC, Houston, TX (US)

(72) Inventor: Volker Peters, Wienhausen (DE)

(21) Appl. No.: 18/629,455

(22) Filed: Apr. 8, 2024

(51) Int. Cl. F16K 31/04

(52) U.S. Cl. CPC F16K 31/043

(57) ABSTRACT

A flow control device having a centrifugal clutch that includes a flyweight having a density between that of a target fluid and a non-target fluid. A valve is operably connected to the clutch. A method for discriminating between a target fluid and a nontarget fluid includes rotating a centrifugal clutch having a flyweight whose density is between the target fluid and the nontarget fluid, radially displacing the flyweight when a fluid density of fluid surrounding the centrifugal clutch is less than the density of the flyweight. The method includes driving a valve with the centrifugal clutch to an actuated position. A wellbore system, including a borehole in a subsurface formation, a string in the borehole, and a fluid density discriminator, disposed within or as a part of the string.

### BACKGROUND

In the resource recovery and fluid sequestration industries fluid discrimination is often important to maintaining efficient and profitable operations. Info control devices commonly rely upon viscosity of fluids to discriminate and function relatively well for systems where viscosity is distinct between target and non-target fluids. Where viscosity of target and non-target fluids are similar, viscosity-based discriminators falter. The art has tried density-based discriminators, but these tend to be gravity sensitive and hence do not provide a complete solution. Since production of light oil from wells that also produce water remains an issue, additional technologies would be beneficial.

### SUMMARY

An embodiment of a flow control device, including a housing, a centrifugal clutch disposed in the housing, the clutch including a flyweight having a density between that of a target fluid and a non-target fluid, and a valve operably connected to the clutch.

An embodiment of a method for discriminating between a target fluid and a nontarget fluid including rotating a hub of a centrifugal clutch having a flyweight whose density is between the target fluid and the nontarget fluid, radially displacing the flyweight when a fluid density of fluid surrounding the centrifugal clutch is less than the density of the flyweight and radially retaining the flyweight when the fluid surrounding the centrifugal clutch has a density greater than the flyweight, engaging a drum of the centrifugal clutch to rotate with the flyweight if fluid density of fluid surrounding the centrifugal clutch is less than the density of the flyweight, and driving a valve to an actuated position.

An embodiment of an inflow control device including a housing, a rotatable fluid density discriminator disposed in the housing, the discriminator discriminating through rotation, during use.

An embodiment of a method for controlling inflow, including conveying a fluid through the inflow control device, selectively transmitting torque of the discriminator to a valve disposed in the housing based upon density of the fluid, and adjusting a position of the valve based upon the density of the fluid.

An embodiment of a wellbore system, including a borehole in a subsurface formation, a string in the borehole, and a fluid density discriminator, disposed within or as a part of the string.

### BRIEF DESCRIPTION OF THE DRAWINGS

The following descriptions should not be considered limiting in any way. With reference to the accompanying drawings, like elements are numbered alike:

FIG. 1 is a section view of a fluid density based flow control device in an open position;

FIG. 1A is a section view of FIG. 1 taken along section line 1A-1A;

FIG. 2 is a section view of the fluid density based flow control device in a closed position;

FIG. 2A is a section view of FIG. 2 taken along section line 2A-2A;

FIG. 3 is a section view of an alternate fluid density based flow control device in a valve open position;

FIG. 4 is a section view of the embodiment of FIG. 3 in a valve closed position;

FIG. 5 is a view of an alternate fluid density discriminator in a non-engaged position;

FIG. 6 is the discriminator of FIG. 5 in an engaged position;

FIG. 7 is a section view of an alternate valve;

FIG. 8 is a section view of an alternate valve;

FIG. 9 is a section view of an alternate valve;

FIG. 10 is a section view of an alternate valve; and

FIG. 11 is a view of a wellbore system including a fluid density discriminator as disclosed herein.

### DETAILED DESCRIPTION

A detailed description of one or more embodiments of the disclosed apparatus and method are presented herein by way of exemplification and not limitation with reference to the Figures.

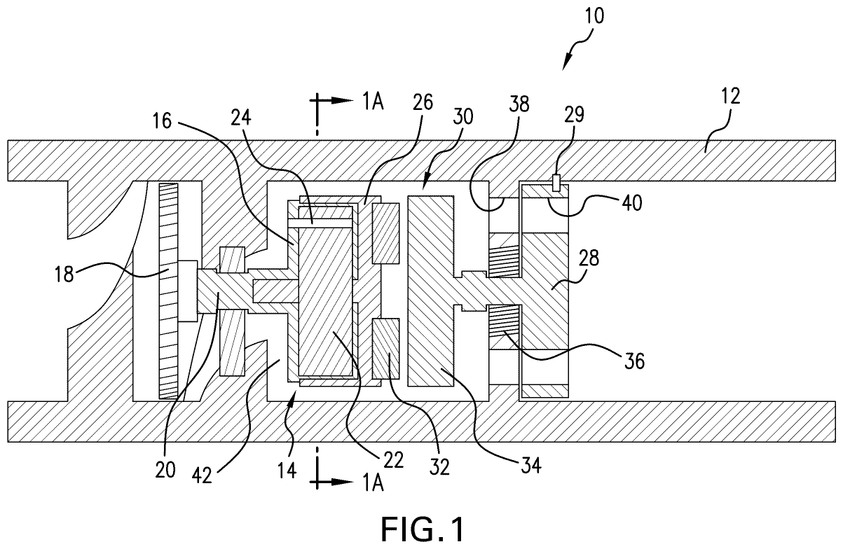

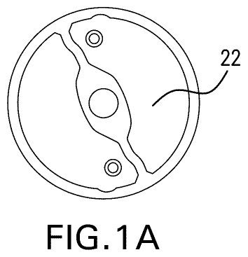

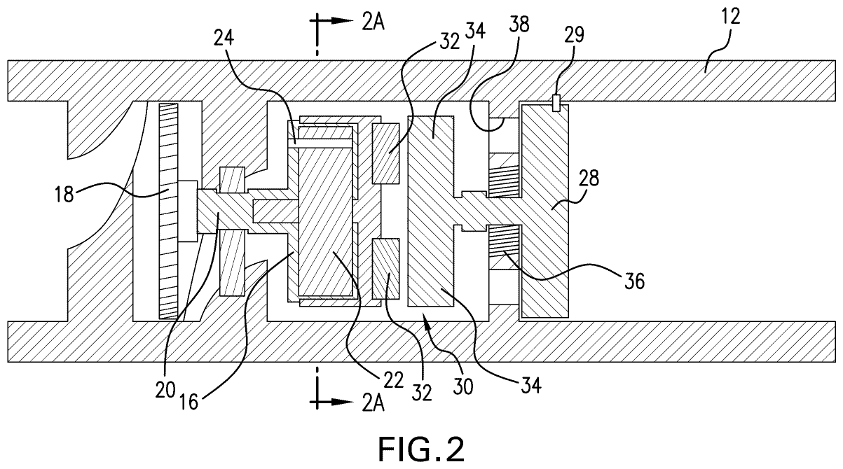

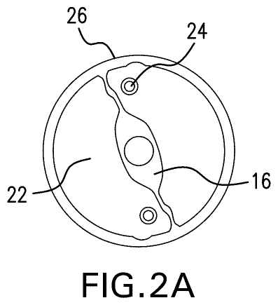

Referring to FIGS. 1 and 2, an embodiment of a flow control device 10 is illustrated. The device 10 is configured to automatically discriminate between a target fluid and a non-target fluid based upon the density of the target fluid versus the density of the non-target fluid. This can be beneficial in industries including downhole industries where it is desirable to pass fluid having a particular density while substantially excluding passage of a fluid having a different density. In a particular iteration of this, it may be that the device 10 is to be used to discriminate between oil (target) and water (non-target) to preferentially facilitate production of oil while minimizing or reducing production of water, for example. It is to be understood that other fluids (different that oil and water or different that one of those) are also contemplated and that the components as described herein may be used to facilitate the production of the less dense fluid (with the valve configured as illustrated) or to facilitate the production of the more dense fluid (with the valve configured in the reverse to what is illustrated) for whatever combination of fluids is presented. Specifically, the valve could move the ports to change when it is open versus when it is closed to the opposite of the illustrations of FIGS. 1 and 2.

For the embodiment of FIGS. 1 and 2, oil (relatively less dense) and water (relatively denser) are both likely to be conveyed through the device 10. It is intended in the illustrated configuration that if water, or predominantly water, is conveyed, the device 10 will close off the flow passages resulting in a substantially reduced flow of fluid through the device 10 (some will leak through and is needed or the fluid surrounding the discriminator would never change once the device 10 closed and it would be a one time device). On the other hand, if the incoming fluid is oil, or predominantly oil, the device will open passages to allow a larger volume of the fluid to flow through the device 10. Again, this could be reversed if it was instead desired to flow the water and impede the oil.

Device 10 comprises a housing 12 that supports a rotational fluid density discriminator 14, such as a centrifugal clutch. The discriminator 14 includes a hub 16 drivingly connected to a drive 18. The drive 18 may be a motor such as an electric motor, regenerative turbine, or any other positive displacement motor such as, for example, a vane motor, a Moineau motor, etc. providing it can generate a torque to be applied to the hub during use. Drive 18 may be disposed in the housing 12 or may be spaced therefrom providing an appropriate torque transfer device 20, such as a driveshaft (that may be far longer than shown if needed due to drive placement) is used to drive the hub 16. The discriminator 14 further includes a flyweight 22 pivotally mounted to the hub 16 at pivot 24. Flyweight 22 is arranged to have a density between that of a target fluid and a non-target fluid. In one case, the target fluid is oil and the non-target fluid is water (or vice versa) but all other fluids having densities between which the density of the flyweight 22 may be configured are contemplated and will work similarly. Further, the discriminator includes a drum 26 that interacts with the flyweight 22 when fluid surrounding the discriminator 14 is of lesser density than that of the flyweight 22. In such conditions, the flyweight 22 will frictionally engage the drum 26 and transfer torque from the hub 16 to the drum 26. A valve 28, which may, in some instances, be a rotary disk valve is actuated by the drum 26 when torque is transferred thereto. In some embodiments, the torque transfer may be direct, with the drum being directly mechanically connected to the valve 28 while in others, an eddy current coupling 30 may be employed between the drum 26 and the valve 28. In the latter case, a magnet 32 is positioned on the drum 26 and a suitable magnetically permeable plate 34 is mechanically connected to the valve 28. The plate 34 is driven by eddy current when the magnet 32 is rotated pursuant to the drum 26 turning. In such an embodiment, the flyweight 22 engages with the drum 26 causing the drum 26 to spin essentially without slip (slippage only occurs for a short period when the flyweights extend upon centrifugal force and engage with the drum 26). When the frictional interaction of the flyweight 22 against the drum 26 causes the drum 26 to rotate, both sides of the discriminator 14, hub 16 with flyweight 22 on the one side and drum 26 on the other side, will rotate at the same speed and thus no permanent wear between flyweight 22 and drum 26 occurs during this portion of the operation.

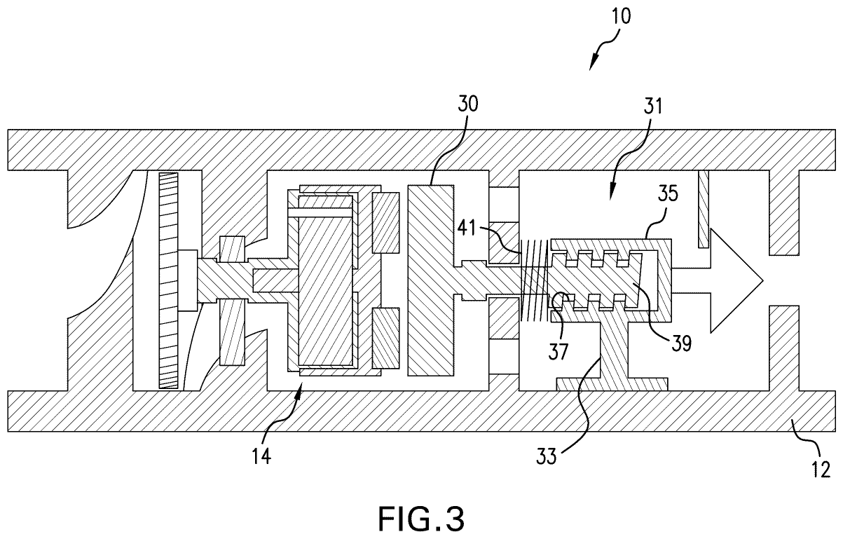

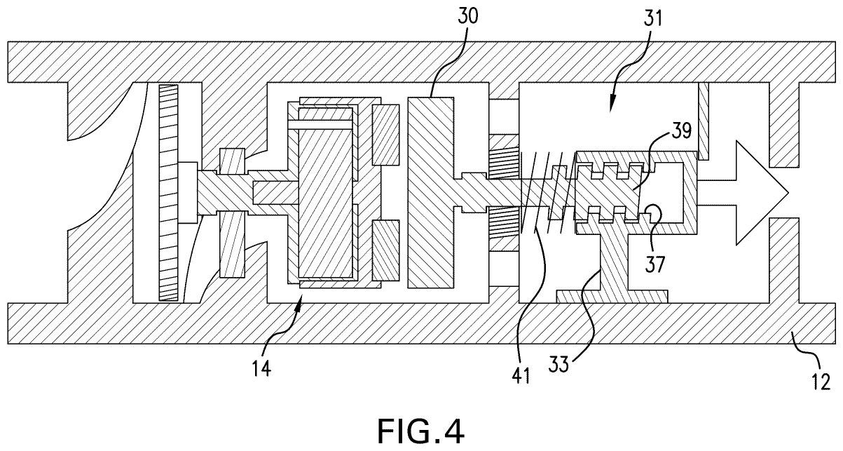

The valve 28 as illustrated, includes a biaser 36 that may be a torsion spring that is biased to either open or close the valve 28 depending upon which fluid is to be the target. In one example, the target fluid is the oil so the valve will open when it is rotated to the open position illustrated in FIG. 1 pursuant to the discriminator 14 conveying the torque to rotate the valve 28. It will be appreciated that the housing 12 include ports 38 that are, in the FIG. 1 view, aligned with openings 40 of the valve 28, allowing fluid to flow. In embodiments, valve 28 may include one or more stops 29 configured to limit angular movement of the valve 28 to one or both of the fully open position and the fully closed position, for example. It is to be appreciated that alternative valve types may be employed, such as a reciprocating type valve instead of the illustrated rotary disk valve. A reciprocating valve may be attached to the discriminator 14/eddy current coupling 30 by means of a rotary to linear translation mechanism 31 such as a crank, screw, lever, etc.). One embodiment of such a reciprocating valve in a flow control device 10 is illustrated in FIGS. 3 and 4. Mechanism 31 includes a torsion support 33 that is configured to support a rotary to linear drive 35. As illustrated the drive 35 includes a female thread 37 with the eddy current coupling 30 including a male engagement 39 but it will be understood that the threaded portions could be reversed with the same results. A valve close spring 41 may be included to urge the reciprocating valve 31 to a closed position.

In operation, the flow control device 10 will receive fluids from the left of FIGS. 1 and 2. The fluid will flow past the drive 18 (in the illustrated case a turbine) and into a compartment 42 of the housing in which the discriminator 14 resides. Due to the transfer device 20, the rotation of the drive 18 is mimicked in the discriminator 14. Rotation of the discriminator will provide a centrifugal (and/or centripetal) force on the flyweight 22 as long as the fluid in the compartment 42 has an overall (potentially a mixed fluid) density that is lower than the density of the flyweight 22. In such a case, the flyweight 22 will move radially outwardly on pivot 24 and begin to drag on the drum 26. The frictional interaction of the flyweight 22 on the drum 26 will begin to cause the drum 26 to rotate. Depending upon whether the drum 26 is connected directly to the valve 28 or if there is interposed the eddy current coupling 30, torque is transferred to the valve 28 which is moved against the bias of biaser 36 to open or close the valve 28 as mentioned above.

As noted above, the drum 26 may be directly mechanically connected to the valve 28 or the eddy current coupling 30 may be employed between the drum 26 and the valve 28. The device 10 will function identically in either configuration. However, without the eddy current coupling 30, the drum 26 would be directly connected to valve 28 and thus all rotational slippage would be borne by the flyweights 22 against the drum 26 (none of the rotational slippage being borne in an eddy current coupling). This will increase wear at the flyweight 22 drum 26 interface. Such wear may limit operational life and require additional maintenance. Since the art tends to avoid maintenance requirements a reduction therein is achievable in embodiments using the eddy current coupling 30 or similar slip-clutch-type connections, such as a viscous fluid coupling or other magnetic-type non-contact coupling.

The drive 18 and thus the discriminator 14 is configured to spin at a relatively high rpm, such as higher than about 300 revolutions per minute (RPM). The flyweight 22 will engage with the drum 26 at higher force the higher the rotary speed is, for the case that the fluid surrounding the discriminator 14 has an overall density that is lower than the density of the flyweight 22. This allows sensing very small density contrasts. For the case that the discriminator is spinning very fast (e.g. higher than about 1000 rpm), only minimum difference between the fluid density and the flyweight density (e.g. less than about 2% difference) will cause engagement and changing of position of the valve 28 from a closed position to an open position or vice versa. Another advantage of spinning the discriminator 14 at a higher speed, is the force available for activation of the valve 28. The higher the rotary speed the greater the centrifugal force of the flyweight 22 and hence the more engagement force against the drum 26. In some examples, if the discriminator 14 is rotated fast enough, the discriminator in an engaged state can overcome high valve torque/force caused by e.g. large fluid pressure drop or flow rate across and through the valve 28. Desirable rotational speed ranges between about 300 rpm for a closed valve 28 up to about 3000 rpm for an open flowpath through valve 28. In other embodiments and largely depending on the drive 18 type, rotary speed can range from about 100 to about 10000 rpm, with lower numbers being associated with a closed flowpath through valve 28, and higher numbers being associated with an open flowpath through valve 28.

It is also to be appreciated that although a common centrifugal clutch (discriminator 14) is shown, other designs, using the same physical principal might also be used. For example, Referring to FIGS. 5 and 6 the discriminator 14 employs linear flyweight guides 43 and optionally retraction springs 45. The flyweights 22 are otherwise essentially the same and will drive the drum under the same conditions discussed above. FIG. 5 illustrates this discriminator embodiment 14 in the not engaged position and FIG. 6 illustrates the embodiment in the engaged position.

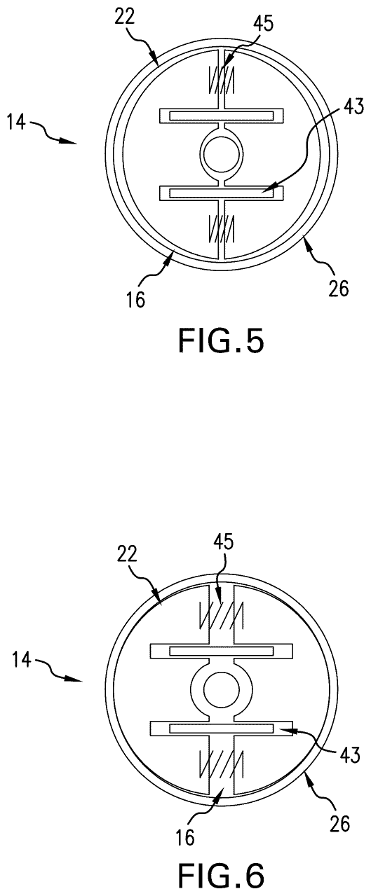

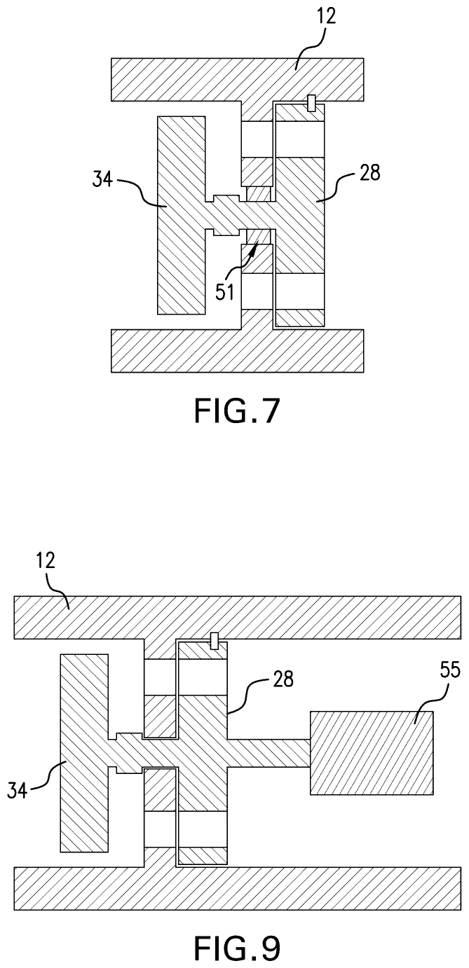

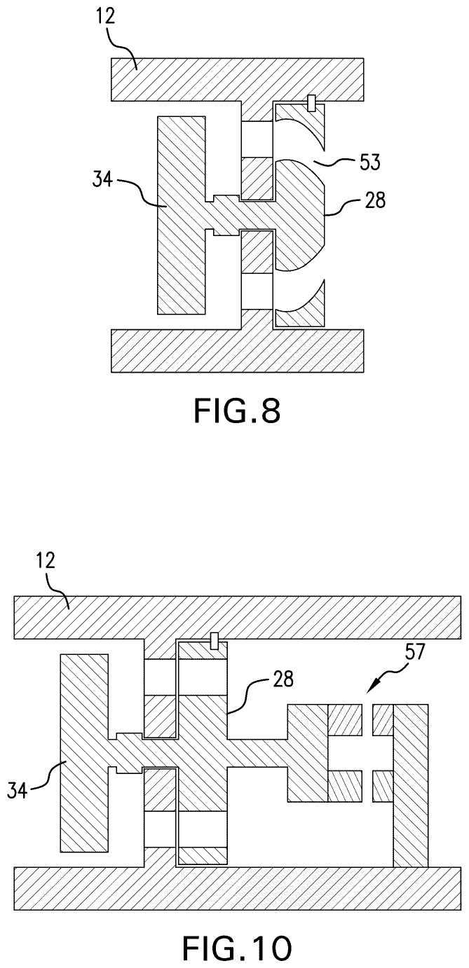

Although the biaser 36 is illustrated as a torsion spring, other means to move the valve into a predefined state may be utilized. Those include rubber elements 51 (FIG. 7), hydraulic biasing by the flow pushed through flow paths 53 (FIG. 8), electromechanical features such as motors 55 (FIG. 9), and magnets 57 (FIG. 10), and so forth.

The device 10 as illustrated in FIGS. 1 and 2 is not sensitive to orientation with respect to gravity since it uses the density contrast between the density of the surrounding fluid and the density of the actuation components (flyweights 22).

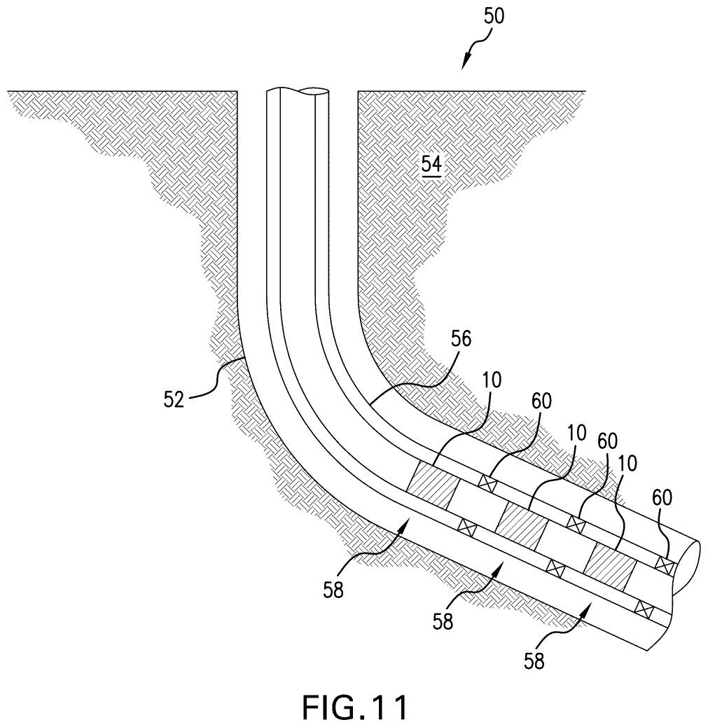

Referring to FIG. 11, a borehole system 50 is illustrated. The system 50 comprises a borehole 52 in a subsurface formation 54. A string 56 (which may be a completion string in some embodiments) is disposed within the borehole 52. A flow control device 10 as disclosed herein is disposed within or as a part of the string 56. It will be appreciated that the string 56 may comprise several flow control devices 10. In some cases it may be desirable to have multiple separated zones 58 or production intervals separated by packers 60. Any of these separated zones 58 may have one or more flow control devices 10. While one section may be producing oil, another section may only produce water. The flow control devices 10 will reduce flow from a section producing an undesirable fluid such as water while another device 10 supports production from a section producing oil by reducing restriction through the device 10 or even stimulates the production through the higher pressure drop relative to what pressure drop would be if all sections were unrestricted.

The device as presented is largely unaffected by debris, sediments or other impurities in the fluid and hence resistant to plugging.

Set forth below are some embodiments of the foregoing disclosure:

Embodiment 1: A flow control device, including a housing, a centrifugal clutch disposed in the housing, the clutch including a flyweight having a density between that of a target fluid and a non-target fluid, and a valve operably connected to the clutch.

Embodiment 2: The device as in any prior embodiment, further comprising a biaser configured to bias the valve to one of a closed position or an open position.

Embodiment 3: The device as in any prior embodiment, wherein the biaser is a torsion spring.

Embodiment 4: The device as in any prior embodiment, further including a drive operably connected to the centrifugal clutch.

Embodiment 5: The device as in any prior embodiment, wherein the drive is a turbine.

Embodiment 6: The device as in any prior embodiment, wherein the drive is a motor.

Embodiment 7: The device as in any prior embodiment, wherein the motor is a positive displacement motor.

Embodiment 8: The device as in any prior embodiment, further including end stop devices for at least one of an open valve and closed valve position.

Embodiment 9: The device as in any prior embodiment, further including an eddy current slip coupling.

Embodiment 10: The device as in any prior embodiment, wherein the valve is a rotary valve.

Embodiment 11: The device as in any prior embodiment, wherein the valve is a reciprocating valve.

Embodiment 12: A method for discriminating between a target fluid and a nontarget fluid including rotating a hub of a centrifugal clutch having a flyweight whose density is between the target fluid and the nontarget fluid, radially displacing the flyweight when a fluid density of fluid surrounding the centrifugal clutch is less than the density of the flyweight and radially retaining the flyweight when the fluid surrounding the centrifugal clutch has a density greater than the flyweight, engaging a drum of the centrifugal clutch to rotate with the flyweight if fluid density of fluid surrounding the centrifugal clutch is less than the density of the flyweight, and driving a valve to an actuated position.

Embodiment 13: The method as in any prior embodiment, wherein the actuated position is open.

Embodiment 14: The method as in any prior embodiment, wherein the driving is rotating.

Embodiment 15: The method as in any prior embodiment, wherein the driving is rotary to linear.

Embodiment 16: The method as in any prior embodiment, further comprising pumping a fluid around the centrifugal clutch.

Embodiment 17: The method as in any prior embodiment, further comprising magnetically coupling the centrifugal clutch to the valve.

Embodiment 18: An inflow control device including a housing, a rotatable fluid density discriminator disposed in the housing, the discriminator discriminating through rotation, during use.

Embodiment 19: A method for controlling inflow, including conveying a fluid through the inflow control device as in any prior embodiment, selectively transmitting torque of the discriminator to a valve disposed in the housing based upon density of the fluid, and adjusting a position of the valve based upon the density of the fluid.

Embodiment 20: A wellbore system, including a borehole in a subsurface formation, a string in the borehole, and a fluid density discriminator as in any prior embodiment, disposed within or as a part of the string.

The use of the terms “a” and “an” and “the” and similar referents in the context of describing the invention (especially in the context of the following claims) are to be construed to cover both the singular and the plural, unless otherwise indicated herein or clearly contradicted by context. Further, it should be noted that the terms “first,” “second,” and the like herein do not denote any order, quantity, or importance, but rather are used to distinguish one element from another. The terms “about”, “substantially” and “generally” are intended to include the degree of error associated with measurement of the particular quantity based upon the equipment available at the time of filing the application. For example, “about” and/or “substantially” and/or “generally” can include a range of ±8% of a given value.

The teachings of the present disclosure may be used in a variety of well operations. These operations may involve using one or more treatment agents to treat a formation, the fluids resident in a formation, a borehole, and/or equipment in the borehole, such as production tubing. The treatment agents may be in the form of liquids, gases, solids, semi-solids, and mixtures thereof. Illustrative treatment agents include, but are not limited to, fracturing fluids, acids, steam, water, brine, anti-corrosion agents, cement, permeability modifiers, drilling muds, emulsifiers, demulsifiers, tracers, flow improvers etc. Illustrative well operations include, but are not limited to, hydraulic fracturing, stimulation, tracer injection, cleaning, acidizing, steam injection, water flooding, cementing, etc.

While the invention has been described with reference to an exemplary embodiment or embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the claims. Also, in the drawings and the description, there have been disclosed exemplary embodiments of the invention and, although specific terms may have been employed, they are unless otherwise stated used in a generic and descriptive sense only and not for purposes of limitation, the scope of the invention therefore not being so limited.

What is claimed is:

1. A flow control device, comprising:
a housing;
a centrifugal clutch disposed in the housing, the clutch including a flyweight having a density between that of a target fluid and a non-target fluid; and
a valve operably connected to the clutch.

2. The device as claimed in claim 1, further comprising a biaser configured to bias the valve to one of a closed position or an open position.

3. The device as claimed in claim 2, wherein the biaser is a torsion spring.

4. The device as claimed in claim 1, further including a drive operably connected to the centrifugal clutch.

5. The device as claimed in claim 4, wherein the drive is a turbine.

6. The device as claimed in claim 4, wherein the drive is a motor.

7. The device as claimed in claim 4, wherein the motor is a positive displacement motor.

8. The device as claimed in claim 1, further including end stop devices for at least one of an open valve and closed valve position.

9. The device as claimed in claim 1, further including an eddy current slip coupling.

10. The device as claimed in claim 1, wherein the valve is a rotary valve.

11. The device as claimed in claim 1, wherein the valve is a reciprocating valve.

12. A method for discriminating between a target fluid and a nontarget fluid comprising:
rotating a hub of a centrifugal clutch having a flyweight whose density is between the target fluid and the nontarget fluid;
radially displacing the flyweight when a fluid density of fluid surrounding the centrifugal clutch is less than the density of the flyweight and radially retaining the flyweight when the fluid surrounding the centrifugal clutch has a density greater than the flyweight;
engaging a drum of the centrifugal clutch to rotate with the flyweight if fluid density of fluid surrounding the centrifugal clutch is less than the density of the flyweight; and
driving a valve to an actuated position.

13. The method as claimed in claim 12, wherein the actuated position is open.

14. The method as claimed in claim 12, wherein the driving is rotating.

15. The method as claimed in claim 12, wherein the driving is rotary to linear.

16. The method as claimed in claim 12, further comprising pumping a fluid around the centrifugal clutch.

17. The method as claimed in claim 12, further comprising magnetically coupling the centrifugal clutch to the valve.

18. An inflow control device comprising:
a housing;
a rotatable fluid density discriminator disposed in the housing, the discriminator discriminating through rotation, during use.

19. A method for controlling inflow, comprising:
conveying a fluid through the inflow control device as claimed in claim 18;
selectively transmitting torque of the discriminator to a valve disposed in the housing based upon density of the fluid; and
adjusting a position of the valve based upon the density of the fluid.

20. A wellbore system, comprising:
a borehole in a subsurface formation;
a string in the borehole; and
a fluid density discriminator as claimed in claim 1, disposed within or as a part of the string.
